(19) United States
(12) Patent Application Publication
(10) Pub. No.: US 2010/0296243 A1
(43) Pub. Date: Nov. 25, 2010

(54) HARD DISK DRIVE FASTENING STRUCTURE AND ELECTRONIC DEVICE EMPLOYING THE SAME

(75) Inventor: Fa-Ning LU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/622,705

(22) Filed: Nov. 20, 2009

(30) Foreign Application Priority Data
May 22, 2009 (CN) 200920303474.8

(51) Int. Cl. G06F 1/16

(52) U.S. Cl. 361/679.58

(57) ABSTRACT

A hard disk drive fastening structure is used in an electronic device to fix a hard disk drive having a female connector. The hard disk drive fastening structure includes a printed circuit board (PCB) and a plurality of spring clips. The PCB includes a male connector. The spring clips fixed on the PCB in two substantially parallel rows and spaced from each other, so as to define a receiving space to receive the hard disk drive. Each spring clip includes a clamping portion and a buffer portion. The clamping portions clamp the hard disk drive collectively. The buffer portions are configured on the clamping portions apart from the receiving space to protect the hard disk drive against shocks. The female connector of the hard disk drive directly mates with the male connector on the PCB.

### BACKGROUND

1. Technical Field

The present disclosure relates to electronic devices, especially to a hard disk drive fastening structure of an electronic device.

2. Description of Related Art

In electronic devices, such as desktop computers, servers, Internet appliances, for example, hard disk drives are required to store data. A frequently used hard disk drive is fixed in a hard disk drive bracket, which is installed into the electronic device. The hard disk drive is electrically connected to a connector of a printed circuit board (PCB) of the electronic device via transmission cables, resulting in increased electronic device size and cost.

It is thus desirable to provide a hard disk drive fastening structure to alleviate the described limitations.

### BRIEF DESCRIPTION OF THE DRAWINGS

FIG. 1 is an assembled view of an electronic device employing a hard disk drive fastening structure in accordance with one embodiment of the present disclosure with a hard disk drive being attached thereto.

FIG. 2 is a perspective view of one embodiment of the hard disk drive fastening structure of FIG. 1.

FIG. 3 is a perspective view of the hard disk drive of FIG. 1.

FIG. 4 is an assembled view of one embodiment of the hard disk drive fastening structure of FIG. 2 with the hard disk drive being attached thereto.

FIG. 5 is a perspective view of one embodiment of a spring clip of the hard disk drive fastening structure of FIG. 2.

FIG. 6 is an assembled view of one embodiment of the hard disk drive fastening structure from another direction of FIG. 4.

### DETAILED DESCRIPTION

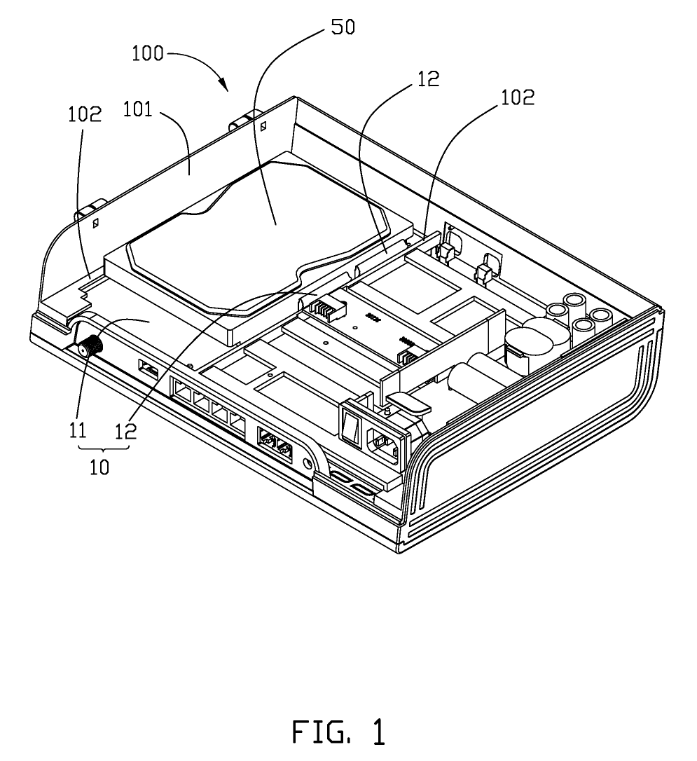

Referring to FIG. 1, an electronic device 100 of the present disclosure includes a hard disk drive fastening structure 10 used to fix a hard disk drive 50. A housing 101 of the electronic device 100 includes a plurality of baffles 102.

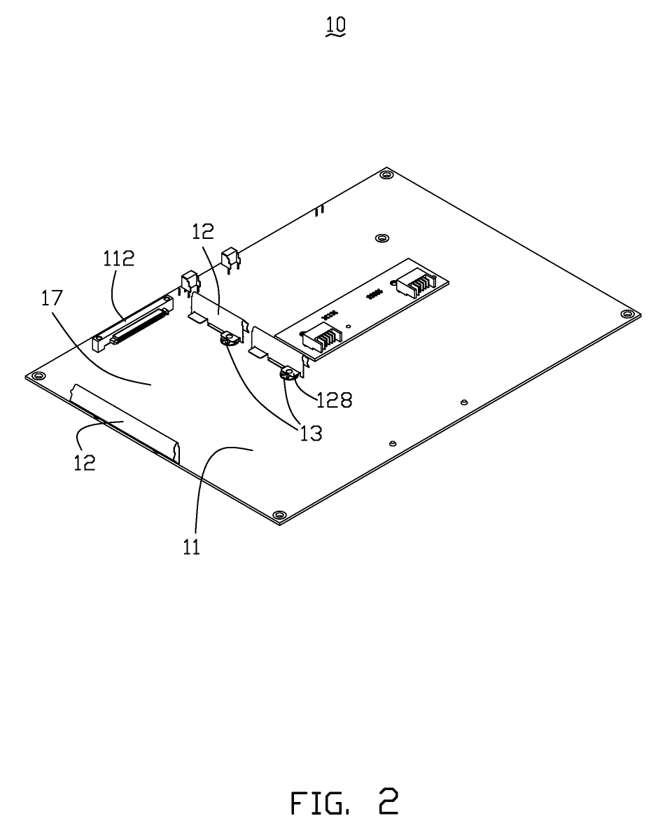

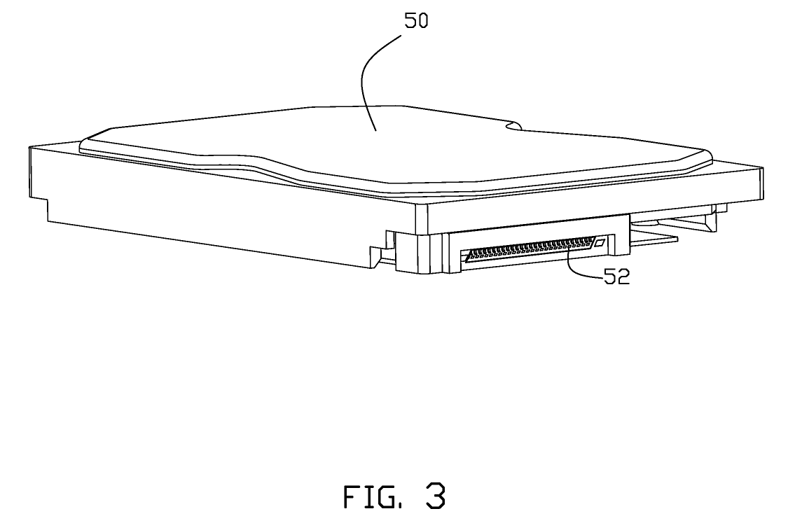

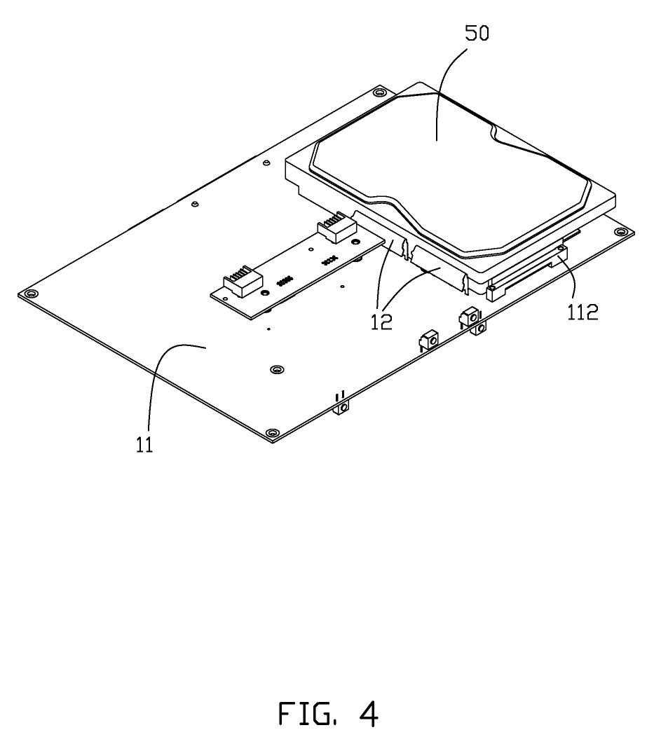

Referring to FIG. 2-FIG. 4, the hard disk drive fastening structure 10 includes a printed circuit board (PCB) 11, a plurality of spring clips 12 fixed to the PCB 11 and a plurality of washers 13. The washers 13 may be made of rubber or other vibration absorbing material. The PCB 11, fixed in the housing 101 of the electronic device 100, includes a male connector 112. The spring clips 12 are located in two substantially parallel rows and spaced from each other so as to define a receiving space 17 to receive the hard disk drive 50. The hard disk drive 50 includes a female connector 52, which directly mates with the male connector 112 on the PCB 11 to transmit data. The washers 13 are located between the spring clips 12 and the PCB 11 to protect the hard disk drive 50 from shocks and vibrations.

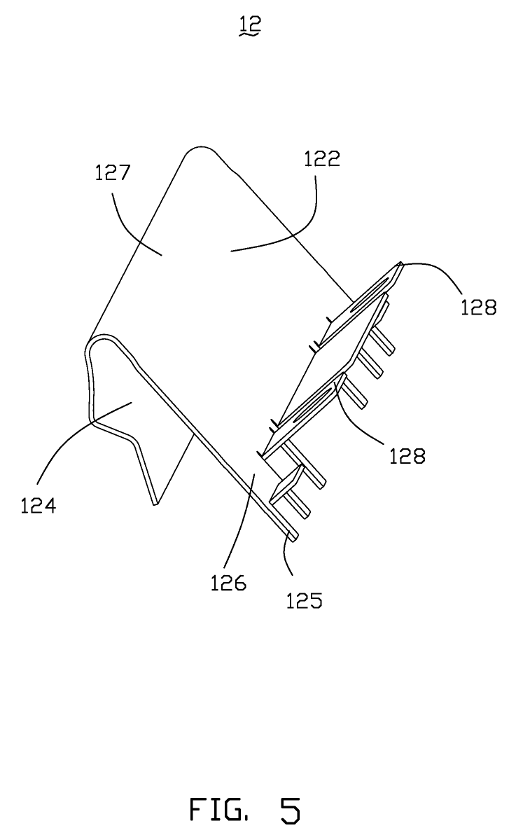

Referring to FIG. 5, each of the spring clips 12 includes a clamping portion 122 and a buffer portion 124. The clamping portions 122 clamp the hard disk drive 50 collectively. The buffer portions 124 are configured on the clamping portions 122 apart from the receiving space 17 to protect the hard disk drive 50 against shocks. In this illustrated embodiment, each of the clamping portions 122 includes a plurality of fastening pins 125 used to position the spring clips 12 on the PCB 11 and a plurality of supporting plates 128. Each of the plurality of supporting plates 128 perpendicularly extends from the clamping portions 122 in parallel with the PCB 11. Here, the supporting plates 128 are configured between two fastening pins 125 by cutting and bending a bottom edge 126 of each clamping portion 122. The buffer portion 124 of each of the spring clips 12 is flexible metal material and extends from a top edge 127 opposite to the bottom edge 126 of the corresponding clamping portion 122.

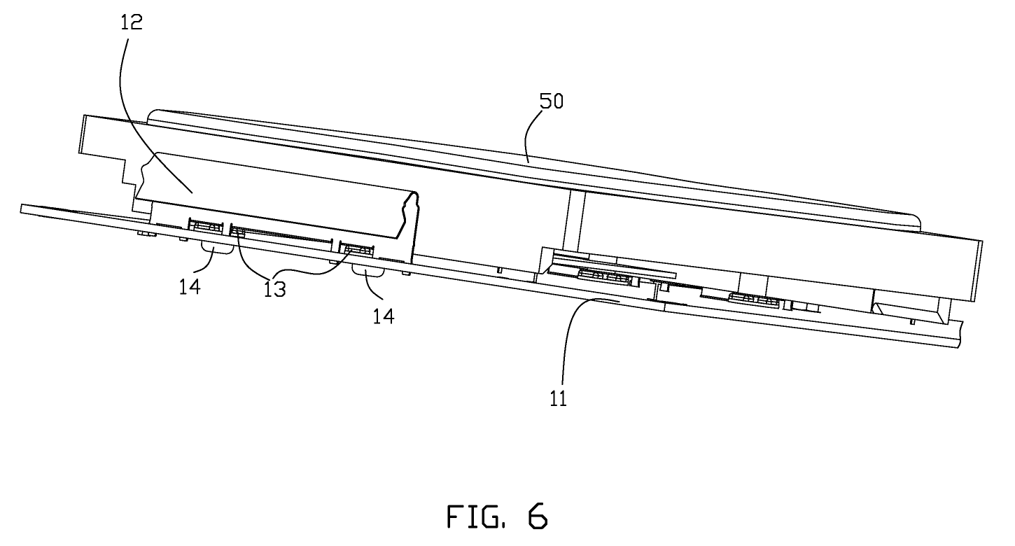

Referring to FIG. 6, the washers 13 are disposed between the plurality of supporting plates 128 and the PCB 11. The hard disk drive 50 is supported on the supporting plates 128 after assembly. A plurality of screws 14 extend through the PCB 11, the plurality of washers 13 and the plurality of supporting plates 128, and are screwed into the hard disk drive 50, to fix the hard disk drive 50 to the hard disk drive fastening structure 10.

To install the hard disk drive 50 in the electronic device 100, the hard disk drive 50 is inserted into the receiving space 17 defined by the spring clips 12, and the female connector 52 of the hard disk drive 50 directly mates with the male connector 112, then the screws 14 are applied, by extending them through the PCB 11, the plurality of washers 13 and the plurality of supporting plates 128, and screwing them into the hard disk drive 50. Therefore, the hard disk drive 50 fixed in the hard disk drive fastening structure 10 is directly connected to the female connector 112 of the PCB 11 without any transmission cable, allowing reduction in size of the electronic device 100.

The buffer portions 124 contact the baffles 102 of the housing 101 of the electronic device 100 so as to elastically connect the hard disk drive 50 to the baffles 102, thereby improving cooling of the hard disk drive 50.

While exemplary embodiments have been described, it should be understood that they have been presented by way of example only and not by way of limitation. The breadth and scope of the disclosure should not be limited by the described exemplary embodiments, but only in accordance with the following claims and their equivalents.

What is claimed is:

1. A hard disk drive fastening structure used in an electronic device to fix a hard disk drive comprising a female connector, the hard disk drive fastening structure comprising:
a printed circuit board (PCB) fixed in the electronic device and comprising a male connector; and
a plurality of spring clips fixed on the PCB in two substantially parallel rows and spaced from each other so as to define a receiving space to receive the hard disk drive, and each of the spring clips comprising a clamping portion and a buffer portion, wherein the clamping portions of the spring clips clamp the hard disk drive collectively, and the buffer portions are configured on the clamping portions apart from the receiving space to protect the hard disk drive against shocks;
wherein the female connector of the hard disk drive directly mates with the male connector on the PCB.

2. The hard disk drive fastening structure as claimed in claim 1, further comprising a plurality of washers located between the spring clips and the PCB.

3. The hard disk drive fastening structure as claimed in claim 2, wherein each of the clamping portions comprises a plurality of fastening pins used to position the spring clips on the PCB.

4. The hard disk drive fastening structure as claimed in claim 3, wherein the spring clips comprise a plurality of supporting plates perpendicularly extending from the clamping portions and parallel with the PCB, and the washers are disposed between the plurality of supporting plates and the PCB.

5. The hard disk drive fastening structure as claimed in claim 4, further comprising a plurality of screws extending through the PCB, the plurality of washers and the plurality of supporting plates, and finally screwed into the hard disk drive.

6. The hard disk drive fastening structure as claimed in claim 5, wherein the buffer portion of each of the spring clips extends from a top edge of the corresponding clamping portion and toward the PCB.

7. An electronic device, comprising:
a hard disk drive comprising a female connector;
a printed circuit board (PCB) comprising a male connector; and
a plurality of spring clips fixed on the PCB in two substantially parallel rows and spaced from each other so as to define a receiving space to receive the hard disk drive, and each of the spring clips comprising a clamping portion and a buffer portion, wherein the clamping portions of the spring clips clamp the hard disk drive collectively, and the buffer portions are configured on the clamping portions apart from the receiving space to protect the hard disk drive against shocks;
wherein the female connector of the hard disk drive directly mates with the male connector on the PCB.

8. The electronic device as claimed in claim 7, further comprising a plurality of washers located between the spring clips and the PCB.

9. The electronic device as claimed in claim 8, wherein each of the clamping portions comprises a plurality of fastening pins used to position the spring clips on the PCB.

10. The electronic device as claimed in claim 9, wherein the spring clips comprise a plurality of supporting plates perpendicularly extending from the clamping portions and parallel with the PCB, and the washers are disposed between the plurality of supporting plates and the PCB.

11. The electronic device as claimed in claim 10, further comprising a plurality of screws extending through the PCB, the plurality of washers and the plurality of supporting plates, and finally screwed into the hard disk drive.

12. The electronic device as claimed in claim 11, wherein the buffer portion of each of the spring clips extends from a top edge of the corresponding clamping portion and toward the PCB.
